(19) United States
(12) Patent Application Publication
(10) Pub. No.: US 2018/0267424 A1
(43) Pub. Date: Sep. 20, 2018

(54) IMAGE FORMING APPARATUS, METHOD OF CONTROLLING IMAGE FORMING APPARATUS, AND CONTROL PROGRAM OF IMAGE FORMING APPARATUS

(71) Applicant: Konica Minolta, Inc., Tokyo (JP)

(72) Inventor: Yuusuke MANDAI, Kyoto-shi (JP)

(73) Assignee: KONICA MINOLTA, INC., Tokyo (JP)

(21) Appl. No.: 15/909,255

(22) Filed: Mar. 1, 2018

(30) Foreign Application Priority Data
Mar. 15, 2017 (JP) 2017-050024

(51) Int. Cl. G03G 15/02

(52) U.S. Cl. CPC G03G 15/0266; G03G 2215/021; G03G 15/0216; G03G 15/04018

(57) ABSTRACT

An image forming apparatus includes: a photosensitive member; a power supply that applies a bias voltage to the photosensitive member to charge a surface of the photosensitive member; a developer that develops an electrostatic latent image on the photosensitive member; an exposing device that forms the electrostatic latent image on the photosensitive member; a hardware processor; and a memory, wherein the memory stores, in advance, a relationship between a suitable AC voltage at which a discharge amount of AC electric discharge is balanced between positive and negative sides and a current value of a specific AC voltage, and the hardware processor controls the bias voltage in an AC charging type, detects the current value at the specific AC voltage, and determines a setting AC voltage on the basis of the relationship.

The entire disclosure of Japanese patent Application No. 2017-050024, filed on Mar. 15, 2017, is incorporated herein by reference in its entirety.

### BACKGROUND

### Technological Field

The present invention relates to an image forming apparatus, and more particularly, to a method of controlling charging of a photosensitive member provided in the image forming apparatus. The image forming apparatus includes an electrophotographic device such as a digital copy machine, a facsimile, a printer, a recording device, a display device, and the like regardless of whether it is for color or monochrome.

### Description of the Related Art

As a method of charging the photosensitive member in the image forming apparatus, a charging roller is mainly employed from the viewpoint of ozone reduction for environmental protection purposes. As a method of charging the charging roller, there are a DC charging type in which a DC voltage (Vdc) is applied and an AC charging type in which an AC voltage (Vpp) is superimposed on the DC voltage (Vdc). The AC charging type has an effect of equalizing the charging electric potential on the surface of the photosensitive member by an AC electric field and has high charging uniformity. Therefore, the AC charging type is being mainly employed currently.

In the related art, JP 2002-72633 A discusses a method of securing a service lifetime of the photosensitive member in the AC charging type, in which a discharge current Iac is calculated from a V-I characteristic by obtaining a current-voltage relationship in a plurality of nodes, and the voltage is controlled such that a predetermined target discharge current Iac can be obtained in order to reduce the discharge current to the minimum.

JP 06-035302 A discusses a control method for determining a correction voltage on the basis of a current-voltage relationship in the DC charging type such that the surface potential becomes constant with respect to a change of the thickness of the surface of the photosensitive member. In this control method, a change of the surface potential of the photosensitive member is read from a change of the current value depending on a change of the resistance of the charging roller or the photosensitive member caused by a thickness change or an environmental change, and the control is performed such that the surface potential becomes a target value.

JP 2007-199094 A discusses a method of determining the AC voltage Vpp using an environmental table prepared in advance regarding three characteristic points of the V-I characteristic in the AC charging type.

In the AC charging type, a control for providing a constant discharge current ΔIac makes it possible to suppress a variation of the discharge amount with respect to a thickness change or an environmental change, compared to a constant current control employed until now. However, strictly to say, it was found that the necessary discharge amount changes depending on a thickness of the photosensitive member, a resistance variation of the charging roller, and an environmental change of the air (including temperature and humidity).

Meanwhile, in the aforementioned DC charging type, the thickness change of the photosensitive member and the environmental change can be recognized uniquely as a change of the current value. However, it is difficult to directly apply the method of setting the target value using this current value to the AC charging type. This is because, by applying an AC bias, (1) nonlinearity occurs when a Vpp-Iac characteristic becomes equal to or higher than a discharge start voltage, and (2) small charging irregularity occurs when the AC current Vpp is short.

A difference of the Vpp-Iac characteristic between the AC charging type and the DC charging type will be described with reference to FIGS. 12 and 13. A difference of the Vpp-surface potential characteristic between the AC charging type and the DC charging type will be described with reference to FIGS. 14 and 15. Behaviors are different between the AC charging type and the DC charging type. FIG. 12 is a diagram illustrating the Vpp-Iac characteristic of the AC charging type. FIG. 13 is a diagram illustrating the Vpp-Iac characteristic of the DC charging type. FIG. 14 is a diagram illustrating the Vpp-surface potential characteristic of the AC charging type. FIG. 15 is a diagram illustrating the Vpp-surface potential characteristic of the DC charging type.

As illustrated in FIGS. 12 and 13, in the case of the AC charging type, the current value significantly changes depending on the AC voltage Vpp applied to an AC electric discharge region. When the discharge amount at the applied voltage Vpp is short, it is difficult to sufficiently detect the charging state.

As illustrated in FIGS. 14 and 15, in the case of the AC charging type, if the AC voltage Vpp is low, an AC positive discharge and an AC negative discharge are not balanced, and small discharge irregularity occurs even when the surface potential becomes the target value unlike the DC charging type. Therefore, the charging is insufficient at the AC voltage Vpp at which the surface potential becomes the target value.

Reduction of the thickness of the photosensitive member is restricted in order to guarantee a long service lifetime of the photosensitive member. As described above, in the related art, the output voltage Vpp is controlled on the basis of a slope of the discharge current or the discharge characteristic by checking the V-I characteristic. However, such a discharge characteristic value changes depending on a resistance change caused by a manufacturing variation, a thickness change, or an environmental change. Therefore, it is difficult to stably minimize the discharge current amount.

### SUMMARY

The present invention has been made in view of the aforementioned problems, and an object of the present invention is to provide an image forming apparatus, a method of controlling the image forming apparatus, and a control program of the image forming apparatus, capable of determining a suitable charging voltage Vpp as a setting voltage depending on a current value at any particular sufficiently high output voltage Vpp in the AC charging type electrophotographic photosensitive member.

To achieve the abovementioned object, according to an aspect of the present invention, an image forming apparatus reflecting one aspect of the present invention comprises: a photosensitive member; a power supply that applies a bias voltage to the photosensitive member to charge a surface of the photosensitive member; a developer that develops an electrostatic latent image on the photosensitive member; an exposing device that forms the electrostatic latent image on the photosensitive member; a hardware processor; and a memory, wherein the memory stores, in advance, a relationship between a suitable AC voltage at which a discharge amount of AC electric discharge is balanced between positive and negative sides and a current value of a specific AC voltage set to be equal to or higher than an AC voltage of a discharge start point and be equal to or lower than an AC voltage at which an image defect occurs due to the electric discharge, and the hardware processor controls the bias voltage in an AC charging type, detects the current value at the specific AC voltage, and determines a setting AC voltage on the basis of the relationship stored in the memory.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a perspective view illustrating an image forming apparatus according to an embodiment of the invention;

FIG. 2 is a side view illustrating a configuration of a toner image forming unit according to an embodiment of the invention;

FIG. 3 is a side view illustrating a drum unit according to an embodiment of the invention;

FIG. 4 is a diagram illustrating a relationship between a current value Iac obtained by applying 2000 V as a specific voltage Vpp for detection and a suitable voltage Vpp at which small charging irregularity does not occur in an embodiment of the invention;

FIG. 5 is a block diagram illustrating a hardware configuration of the image forming apparatus of Example 1;

FIG. 6 is a diagram illustrating a relationship between a change of the specific voltage Vpp and the suitable voltage Vpp in Example 1;

FIG. 7 is a diagram illustrating influence of a Vpp difference on thickness reduction in Example 1;

FIG. 8 is a diagram illustrating a Vpp determination control flow in Example 1;

FIG. 9 is a diagram illustrating a Vpp determination control flow in Example 2;

FIG. 10 is a diagram illustrating a Vpp determination control flow in Example 3;

FIG. 11 is a diagram illustrating a Vpp determination control flow in Example 4;

FIG. 12 is a diagram illustrating a Vpp-Iac characteristic in the case of an AC charging type;

FIG. 13 is a diagram illustrating a Vpp-Iac characteristic in the case of a DC charging type;

FIG. 14 is a diagram illustrating a Vpp-surface potential characteristic in the case of the AC charging type; and

FIG. 15 is a diagram illustrating a Vpp-surface potential characteristic in the case of the DC charging type.

### DETAILED DESCRIPTION OF EMBODIMENTS

Hereinafter, a photosensitive member charging device, a photosensitive member charging method, and an image forming apparatus according to one or more embodiments of the present invention will be described with reference to the drawings. However, the scope of the invention is not limited to the disclosed embodiments. In the embodiments described below, when referring to the number, quantity, and the like, the scope of the present invention is not necessarily limited to the number, amount, and the like unless specified otherwise. Like reference numerals denote like elements, and some parts will not be described redundantly. In the drawings, some parts are not illustrated at actual scales of dimensions, but are illustrated by changing the scale in order to clarify the structure and facilitate the understanding of the structure.

The image forming apparatus is a multi-function peripheral (MFP) having a scanner function, a copier function, a printer function, a facsimile function, a data communication function, and a server function.

In the scanner function, images of set originals are read and stored in a hard disk drive (HDD). In the copier function, an image is printed (image formation) on a sheet or the like. In the printer function, a print command is received from an external terminal such as a personal computer (PC), and printing is performed on a sheet in response to the command. In the facsimile function, facsimile data is received from an external facsimile device or the like and is stored in the HDD or the like. In the data communication function, data is transmitted to or received from a connected external device. In the server function, data stored in the HDD is shared with a plurality of users.

The image forming apparatus forms an image on the basis of a two-component development type electrophotographic method. The image forming apparatus exposes an image carrier (hereinafter, referred to as a photosensitive member) charged, for example, by a charging roller. The image forming apparatus develops the formed electrostatic latent image using a developer carrier of the development device to form an image. As a charging bias voltage is applied to the charging roller, the image carrier is charged. In the event of development, a development bias voltage having the same polarity as that of the charging bias voltage is applied to the developer carrier.

In order to prevent the carrier from adhering to the image carrier and suppress consumption of the toner, it is important to provide a relationship between timings for applying the charging bias voltage and the development bias voltage by appropriately maintaining a potential difference between the image carrier surface and the developer carrier.

(Configuration of Image Forming Apparatus 1)

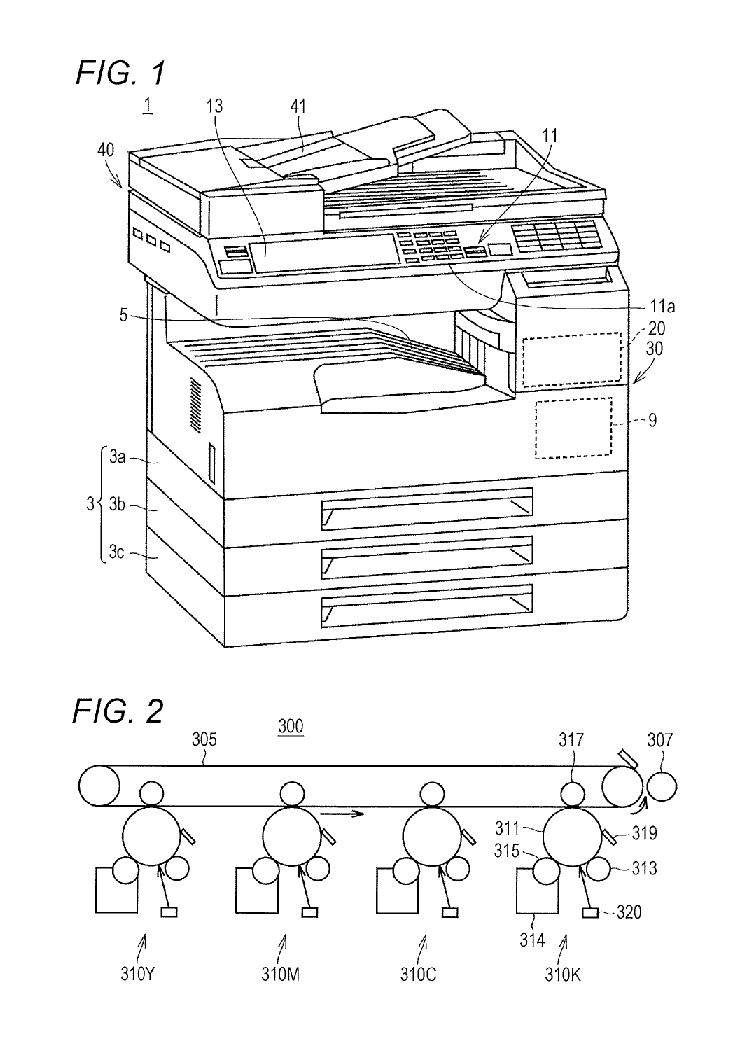

A configuration of the image forming apparatus 1 will be described with reference to FIG. 1. FIG. 1 is a perspective view illustrating an image forming apparatus according to an embodiment of the invention.

The image forming apparatus 1 includes a sheet feeding cassette 3, a sheet discharge tray 5, a power supply 9, a manipulation unit 11, a controller 20, a print unit 30, and a scanning unit 40. The controller 20 has a central processing unit (CPU) 21 or the like as described below. The controller 20 and the print unit 30 are disposed in a casing of the image forming apparatus 1.

The image forming apparatus 1 has three sheet feeding cassettes 3 (3a, 3b, and 3c). For example, sheets having different sizes (such as B5, A4, and A3) are loaded on the sheet feeding cassette 3. The sheet feeding cassette 3 is disposed in a lower part of the image forming apparatus 1 such that it can be inserted into and drawn from the casing of the image forming apparatus 1. In the event of printing, the sheets loaded on each sheet feeding cassette 3 are fed from the sheet feeding cassette 3 one by one and are delivered to the print unit 30. The number of the sheet feeding cassettes 3 is not limited to three, but more or less number of cassettes may also be possible.

The sheet discharge tray 5 is disposed above the print unit 30 and under the scanning unit 40 inside the casing of the image forming apparatus 1. The sheet on which an image is formed by the print unit 30 is discharged from the inside of the casing to the sheet discharge tray 5.

The power supply 9 is provided inside the casing of the image forming apparatus 1. The power supply 9 is connected to a commercial power source and supplies power to the controller 20, the print unit 30, or the like on the basis of the commercial power.

The manipulation unit 11 is disposed in an upper front side of the image forming apparatus 1. The manipulation unit 11 is provided with a plurality of manipulation buttons 11a that can be pressed and manipulated by a user. A display panel 13 is arranged in the manipulation unit 11. The display panel 13 is, for example, a liquid crystal display (LCD) having a touch panel. The display panel 13 displays a guide screen for a user or a manipulation button to receive a touch manipulation from a user. The display panel 13 is controlled by the CPU 21 to perform display.

As a user manipulates the manipulation button 11a and the display panel 13, the manipulation unit 11 transmits a manipulation signal or a predetermined command to the CPU 21 in response to this manipulation. A user may execute various operations on the image forming apparatus 1 by manipulating the manipulation unit 11.

The print unit 30 has a toner image forming unit 300 (refer to FIG. 2), a sheet feeding unit (not illustrated), and a fixer (not illustrated). The print unit 30 forms an image on a sheet in an electrophotographic manner. The print unit 30 is configured to synthesize four color images in a so-called tandem type and form a color image on a sheet. The configuration of the toner image forming unit 300 will be described below.

The sheet feeding unit has a sheet feeding roller, a conveyance roller, a motor for driving the sheet feeding roller and the conveyance roller, and the like. The sheet feeding unit feeds a sheet from the sheet feeding cassette 3 and conveys it inside the casing of the image forming apparatus 1. The sheet feeding unit discharges a sheet on which an image is formed from the casing of the image forming apparatus 1 to the sheet discharge tray 5 or the like.

The fixer has a heating roller and a pressing roller. The fixer conveys the sheet on which the toner image is formed while nipping it between the heating roller and the pressing roller in order to heat and press the sheet. As a result, the fixer forms an image on the sheet by melting the toner adhering on the sheet and fixing it on the sheet.

The scanning unit 40 is disposed in an upper part of the casing of the image forming apparatus 1. The scanning unit 40 has an automatic document feeder (ADF) 41. The scanning unit 40 executes the aforementioned scanning function. The scanning unit 40 scans the original laid on a transparent flatbed table using a contact image sensor to read the original as image data. In addition, the scanning unit 40 reads image data of a plurality of originals set on the original tray using the contact image sensor while sequentially feeding them to the ADF 41.

(Toner Image Forming Unit 300)

A configuration of the toner image forming unit 300 will be described with reference to FIG. 2. FIG. 2 is a side view illustrating a configuration of the toner image forming unit. The toner image forming unit 300 has an intermediate transfer belt 305, a transfer roller 307, four sets of drum units 310Y, 310M, 310C, and 310K (hereinafter, also collectively referred to as a drum unit 310), and a laser scanning unit (example of an exposing unit) 320.

The intermediate transfer belt 305 has a loop shape and is looped around a pair of rollers. The intermediate transfer belt 305 is rotated in synchronization with the sheet feeding unit. The transfer roller 307 is arranged to face a contact portion of one of the rollers of the intermediate transfer belt 305. A sheet is conveyed while it is nipped between the intermediate transfer belt 305 and the transfer roller 307.

Each drum unit 310 has a photosensitive member 311, a charging roller 313, a developer 314, a belt transfer roller 317, and a cleaning blade 319. Four drum units 310 are provided to form each of yellow (Y), magenta (M), cyan (C), and black (K) images of the CMYK color system. Four sets of drum units 310 are arranged side by side along the intermediate transfer belt 305. The laser scanning unit 320 is arranged so as to scan laser light onto the photosensitive member 311 of each drum unit 310. The laser scanning unit 320 may be provided in each drum unit 310, or may be provided such that laser light is scanned from a single laser scanning unit 320 to the photosensitive members 311 of each drum unit 310.

In the toner image forming unit 300, each laser scanning unit 320 forms an electrostatic latent image on the photosensitive member 311 of each drum unit 310 on the basis of the image data for each color of the YMCK color system. The developer 314 develops the electrostatic latent image formed on each photosensitive member 311 using the developing roller (example of the developer carrier) 315 to form the toner image of each color on each photosensitive member 311. Each photosensitive member 311 transfers the toner image onto the intermediate transfer belt 305 to form a specular image of the toner image to be formed on the sheet on the intermediate transfer belt 305 (primary transfer). Then, the toner image formed on the intermediate transfer belt 305 is transferred to the sheet using the transfer roller 307 to form the toner image on the sheet (secondary transfer).

(Drum Unit 310)

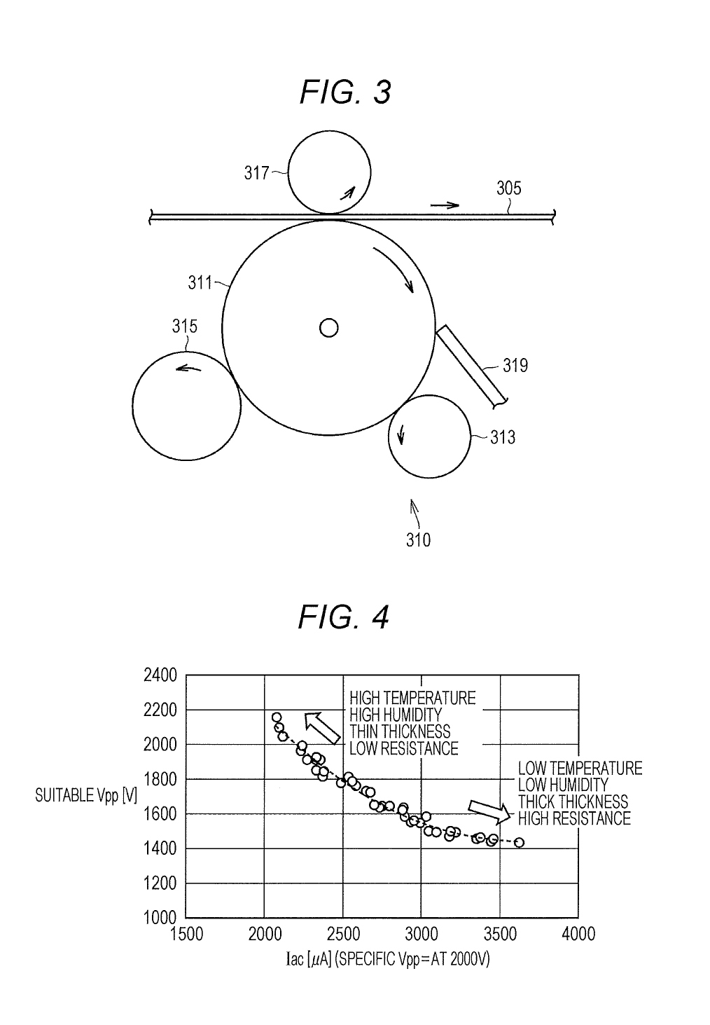

A configuration of the drum unit 310 will be described in details with reference to FIG. 3. FIG. 3 is a side view illustrating the drum unit. Each drum unit 310 is configured similarly to that of a typical image forming apparatus of the related art. The photosensitive member 311 has a drum shape, and an organic photoconductor/photoreceptor (OPC) is provided in its trunk portion. Around the photosensitive member 311, the charging roller 313, the developing roller 315, the belt transfer roller 317, and the cleaning blade 319 are sequentially arranged along the rotation direction of the photosensitive member 311.

Each drum unit 310 charges the surface of the photosensitive member 311 in a roller charging method. That is, the charging roller 313 electrically charges the surface of the photosensitive member 311 by applying a high charging bias voltage between the charging roller 313 and the photosensitive member 311. The laser scanning unit 320 irradiates the charged portion of the surface of the photosensitive member 311 with laser light to attenuate the potential. As a result, an electrostatic latent image is formed on the surface of the photosensitive member 311.

The developer 314 forms a toner image by attaching toner to the electrostatic latent image formed on the surface of the photosensitive member 311. The developer 314 is a two-component developing type. The developer 314 transfers the toner of the developing roller 315 to the photosensitive member 311 and forms an electrostatic latent image by applying a development bias voltage to the developing roller 315. The development bias voltage is a bias voltage having the same polarity as that of the charging bias voltage.

The belt transfer roller 317 applies charges while nipping the intermediate transfer belt 305 between the photosensitive member 311 and the belt transfer roller 317 to transfer a toner image from the photosensitive member 311 to the intermediate transfer belt 305. The cleaning blade 319 comes into contact with the surface of the photosensitive member 311 to collect the toner remaining on the surface of the photosensitive member 311.

(Vpp Determination Control)

In the image forming apparatus 1 having the aforementioned configuration, a suitable voltage Vpp is set at all times with respect to a change of the resistance/impedance caused by a change of temperature and humidity or a change of the thickness during charging of the photosensitive member 311 based on the AC charging type using the following method.

(1) The Vpp-Iac characteristic becomes nonlinear when the voltage is equal to or higher than the discharge start voltage. That is, a certain fixed voltage Vpp (specific voltage Vpp) at which the photosensitive member 311 is sufficiently charged is set, and a current value at this specific voltage Vpp is used as an input.

If the voltage Vpp changes depending on a change of resistance or impedance, the flowing current also changes. For this reason, a change of the current during AC electric discharge with respect to a change of resistance or impedance is uniquely determined by fixing the voltage Vpp at the time of detection to a value at which the current is sufficiently discharged.

Specifically, in order to detect a characteristic during the AC electric discharge, it is necessary to set the specific voltage Vpp to be equal to or higher than the voltage Vpp at a discharge start point or higher. In addition, if the voltage Vpp is too high, in particular, an external additive leaking in cleaning due to electric discharge under the environment of high humidity reacts with moisture in the air to form a film on the surface of the photosensitive member 311, so that a charging failure occurs, and this generates an image defect. Therefore, it is necessary to set the voltage Vpp within the range that the image defect does not occur.

(2) If the voltage Vpp is short, small charging irregularity occurs. That is, the voltage Vpp at which no small charging irregularity occurs is set as a target value. A discharge amount at which positive and negative sides of the AC electric discharge are balanced is obtained by increasing the voltage Vpp, and this value is set as the suitable voltage Vpp. Here, the discharge amount at which positive and negative sides of the AC electric discharge are balanced means a range of ±10% with respect to the applied voltage. It is desirable to measure the AC discharge amount using an image forming apparatus for experiment. Alternatively, as an alternative characteristic, uniformity of the surface potential at a small region or the amount of black and white spots caused by charging irregularity after development may be set to be equal to or smaller than a predetermined value.

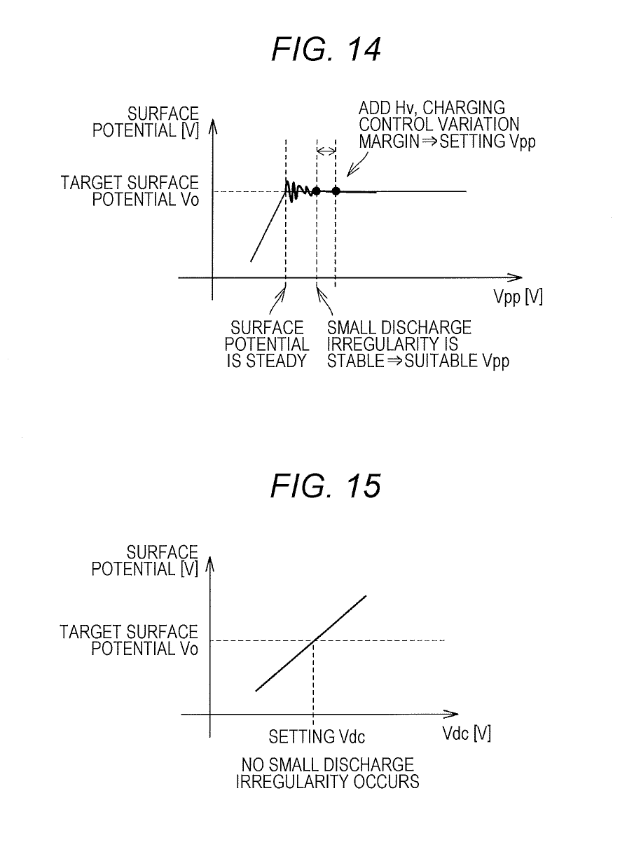

In FIGS. 14 to 17, the setting voltage Vpp applied to the image forming apparatus in practice is an AC voltage obtained by setting a certain amount of positive margin considering a detection variation of the Hv output or the charging control.

FIG. 4 illustrates a result when the suitable voltage Vpp is set on the basis of the aforementioned method. FIG. 4 illustrates a result of checking a relationship between the discharge current value Iac obtained by applying 2000 V as the specific voltage Vpp for detection and the suitable voltage Vpp at which small charging irregularity does not occur.

As illustrated in FIG. 4, it is recognized that there is a relationship between the discharge current Iac of 2000 V and the suitable voltage Vpp even by changing the resistance of the charging roller 313, the thickness of the photosensitive member 311, and the error condition of the environmental change within a range of upper and lower limits.

### Example 1: Vpp Determination Control

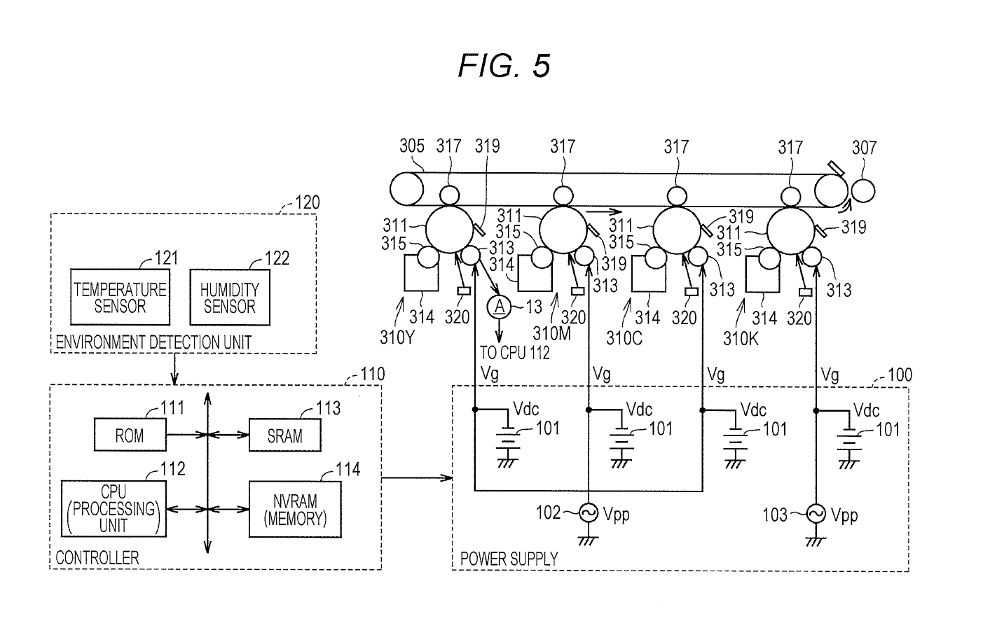

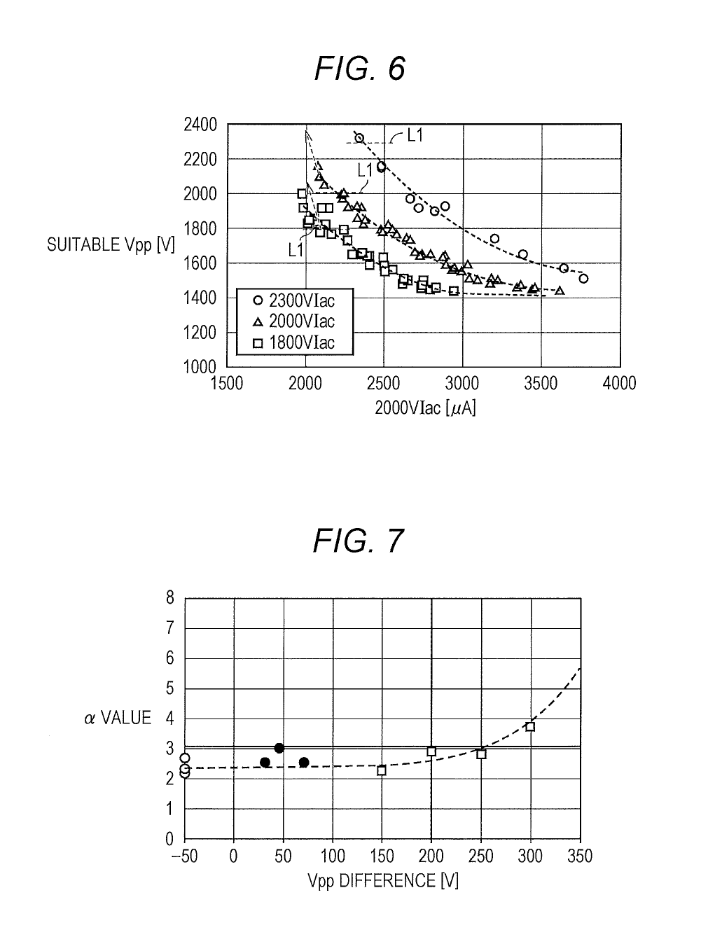

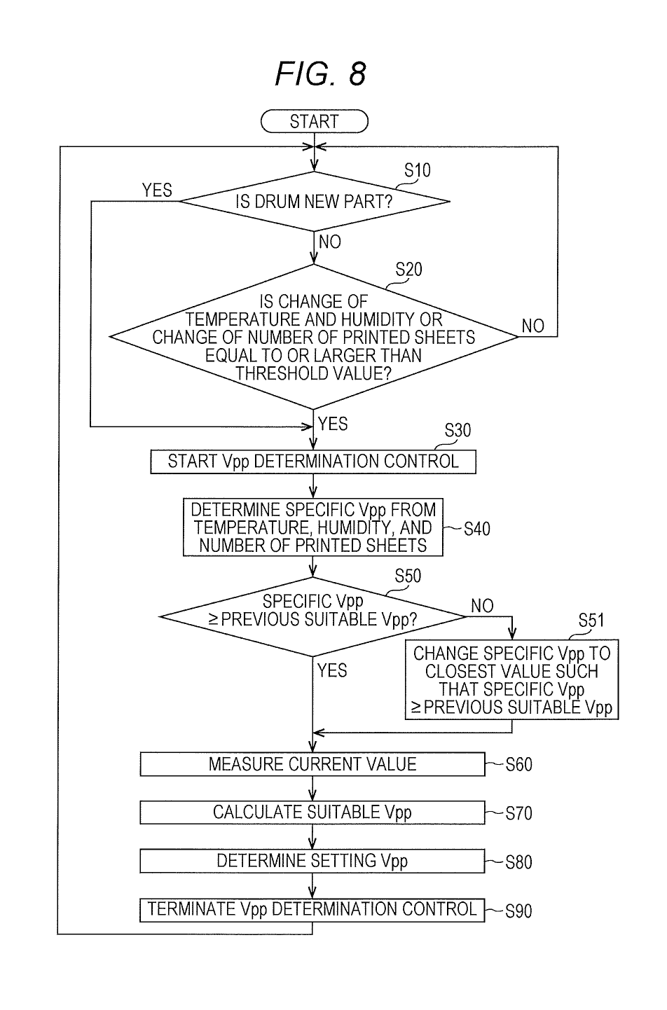

A Vpp determination control of Example 1 will be described with reference to FIGS. 5 to 8. FIG. 5 is a block diagram illustrating a hardware configuration of the image forming apparatus 1. FIG. 6 is a diagram illustrating a relationship between a change of the specific voltage Vpp and the suitable voltage Vpp. FIG. 7 is a diagram illustrating influence of the Vpp difference on thickness reduction. FIG. 8 is a diagram illustrating the Vpp determination control flow.

A hardware configuration of the image forming apparatus 1 will be described with reference to FIG. 5. The drum unit 310 has a photosensitive member 311, a charging roller 313, and a cleaning blade 319 as described above. An AC bias in which an AC voltage Vpp is superimposed on a DC voltage Vdc is applied from the power supply 100 to the charging roller 313. A temperature sensor 121 and a humidity sensor 122 are installed in the image forming apparatus 1 as an environment detection unit 120.

The charging controller 110 has a computation CPU 112 and a memory 114 for storing information. A relationship between a suitable AC voltage (hereinafter, referred to as a suitable voltage Vpp) at which the discharge amount of the AC electric discharge is balanced between the positive and negative sides and a current value of a specific AC voltage (hereinafter, referred to as a specific voltage Vpp) set to be equal to or higher than the AC voltage of the discharge start point and be equal to or lower than the AC voltage at which an image defect occurs due to electric discharge is obtained through experiments, and is stored in the memory 114. The relationship may be stored as an approximation formula or a table.

In the image forming apparatus 1, the charging controller 110 detects with an event of new part installation, when the temperature changes by 5° C. or more, or the humidity changes by 20% or more, and/or, for example, when 1K or more sheets have been printed as a durable sheet number as a trigger, and executes the “charging Vpp determination control” (steps S10 to S30 in FIG. 8).

In the “charging Vpp determination control”, a discharge current Iac is detected by applying 2000 V as the specific voltage Vpp, and the suitable voltage Vpp is calculated on the basis of the relationship between the discharge current Iac and the suitable voltage Vpp stored in advance (steps S40 to S70 in FIG. 8).

The current value of the discharge current Iac is obtained from an average value of the sampling data for a rotation time of approximately one cycle of the photosensitive member 311. A setting voltage Vpp offset, for example, by 50 V by assuming an Hv output variation and a variation caused by the charging control in the calculated suitable voltage Vpp is applied as the output (steps S80 to S90 in FIG. 8).

FIG. 6 illustrates a relationship between the current value of the discharge current Iac obtained by changing the specific voltage Vpp and the suitable voltage Vpp. FIG. 6 illustrates a relationship between a change of the specific voltage Vpp and the suitable voltage Vpp. In the relationship of “suitable voltage Vpp>specific voltage Vpp” (upper side over the line L1 in FIG. 6), a relationship between the current and the suitable voltage Vpp is collapsed when a voltage of 1800 V is applied. When a voltage of 1800/2000 V is applied, a slope of the suitable voltage Vpp against the current value is more upright, and the detection accuracy at the suitable voltage Vpp decreases, compared to when a voltage of 2300 V is applied. Therefore, in order to secure determination accuracy, it is necessary to set the suitable voltage Vpp to be lower than the specific voltage Vpp. If the specific voltage Vpp is set to 2300 V, in this configuration, the specific voltage Vpp does not decrease below the suitable voltage Vpp.

FIG. 7 illustrates influence of the Vpp difference on the thickness reduction. As illustrated in FIG. 7, the thickness reduction is promoted when a difference between the applied voltage Vpp and the suitable voltage Vpp increases. Therefore, it is desirable to set the difference between the specific voltage Vpp and the suitable voltage Vpp to be equal to or smaller than 200 V. In this difference level, filming does not occur under the environment of high humidity.

A plurality of specific voltages Vpp may be provided in order to suppress the difference between the specific voltage Vpp and the suitable voltage Vpp to be equal to or smaller than 200 V. For example, in this configuration, the suitable voltage Vpp is set to a range of 1400 to 2400 V. Therefore, if the specific voltage Vpp is set to five levels including 1600 V, 1800 V, 2000 V, 2200 V, and 2400 V with an interval of 200 V, the difference is suppressed to 200 V or smaller.

A high suitable voltage Vpp is necessary when the resistance increases under the low-temperature and low-humidity environment, at an initial stage of aging in which the remaining thickness is large, and when the resistance of the charging roller is high. This relationship also applies to the specific voltage Vpp. On the basis of this relationship, it is possible to obtain an approximate range of the suitable voltage Vpp from the number of printed sheets as an alternative value instead of the temperature and humidity and the thickness using a table stored in advance without detection. Therefore, it is possible to determine the specific voltage Vpp on the basis of the temperature and humidity during use and the number of printed sheets.

If the higher one selected from the specific voltages Vpp obtained from the table with reference to the previous values of the suitable voltage Vpp is used, it is conceived that there is no collapse of the relationship between the specific voltage Vpp and the suitable voltage Vpp (step S51 of FIG. 8). If the specific voltage Vpp is lower than the detected suitable voltage Vpp, the detection may be performed again using a specific voltage Vpp higher by an interval of 200 V as an error process.

In this manner, when a plurality of specific AC voltages are provided, the specific AC voltage may be selected depending on the temperature and humidity, the number of printed sheets, the thickness of the surface of the photosensitive member, and any one of the previous specific AC voltages.

### Example 2

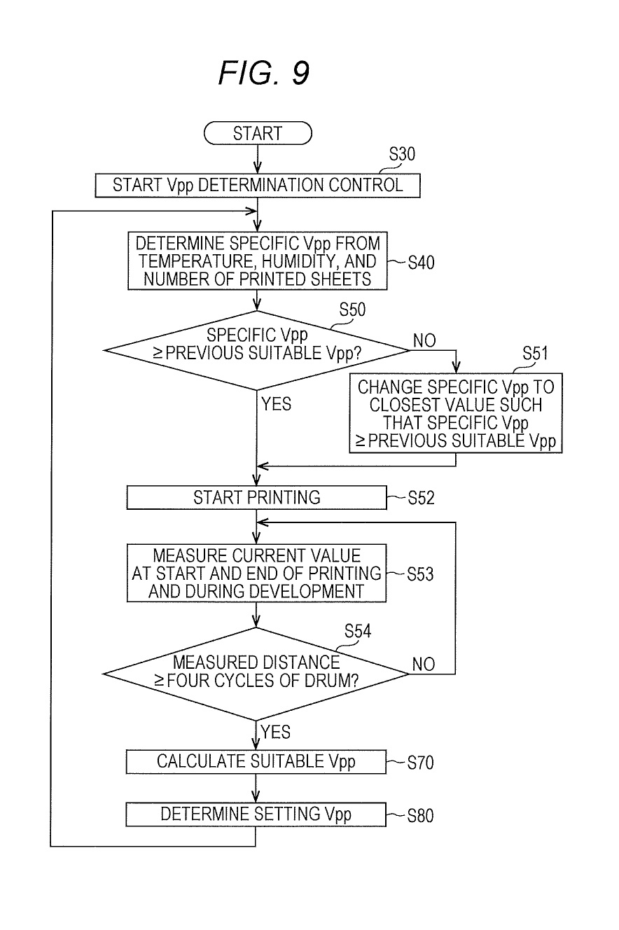

Next, the Vpp determination control in Example 2 will be described with reference to FIG. 9. FIG. 9 is a diagram illustrating the Vpp determination control flow in Example 2. For steps similar to those of Example 1, like reference numerals denote like elements, and they will not be described redundantly.

The configuration of the drum unit employed in Example 2 is similar to that of Example 1 of FIG. 5. The Vpp determination control is performed at the start and the end of printing or during development (step S53). As a result, extra driving time may be eliminated due to the charging Vpp determination control. However, each of the start time, the end time, and the development time is shorter than one cycle of the photosensitive member 311. Therefore, the suitable voltage Vpp may be obtained for an average value of the current value corresponding to four cycles of the photosensitive member 311 by performing the Vpp determination control whenever the printing is performed (step S54).

### Example 3

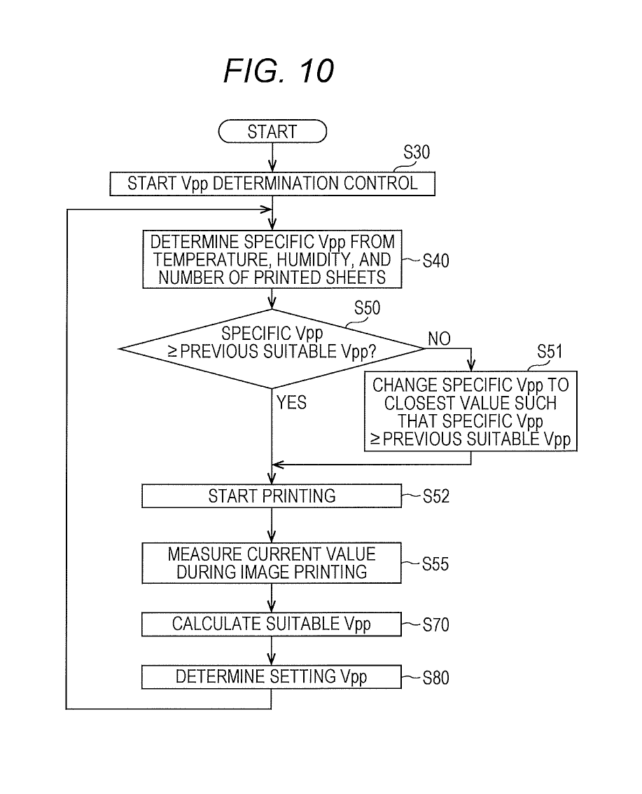

Next, the Vpp determination control in Example 3 will be described with reference to FIG. 10. FIG. 10 is a diagram illustrating the Vpp determination control flow of Example 3. For steps similar to those of Examples 1 and 2, like reference numerals denote like elements, and they will not be described redundantly.

In Example 3, the Vpp determination control is performed while an image is printed during the printing (step S55). The suitable voltage Vpp is calculated from the current value for each single image, and is reflected on the bias output for the next image. As a result, extra driving time may be eliminated due to the charging Vpp determination control.

However, since the printing is performed at the specific voltage Vpp for the actual printing, the specific voltage Vpp may be set within a difference range at which a charging failure or an image defect does not occur more than other detection methods. Therefore, it is desirable to increase the number of the specific voltages Vpp that can be used within a difference range of 50 to 100 V.

If the Vpp determination control is performed at all times, the printing is performed by applying a variation corresponding to the step interval of the specific voltage Vpp at all times. As a result, the Vpp determination accuracy may not improve even when the suitable voltage Vpp is calculated with effort. Therefore, it is desirable not to use the determination control at the specific voltage Vpp as frequent as possible, and it is desirable to use the determination control while the voltage Vpp does not significantly change.

### Example 4

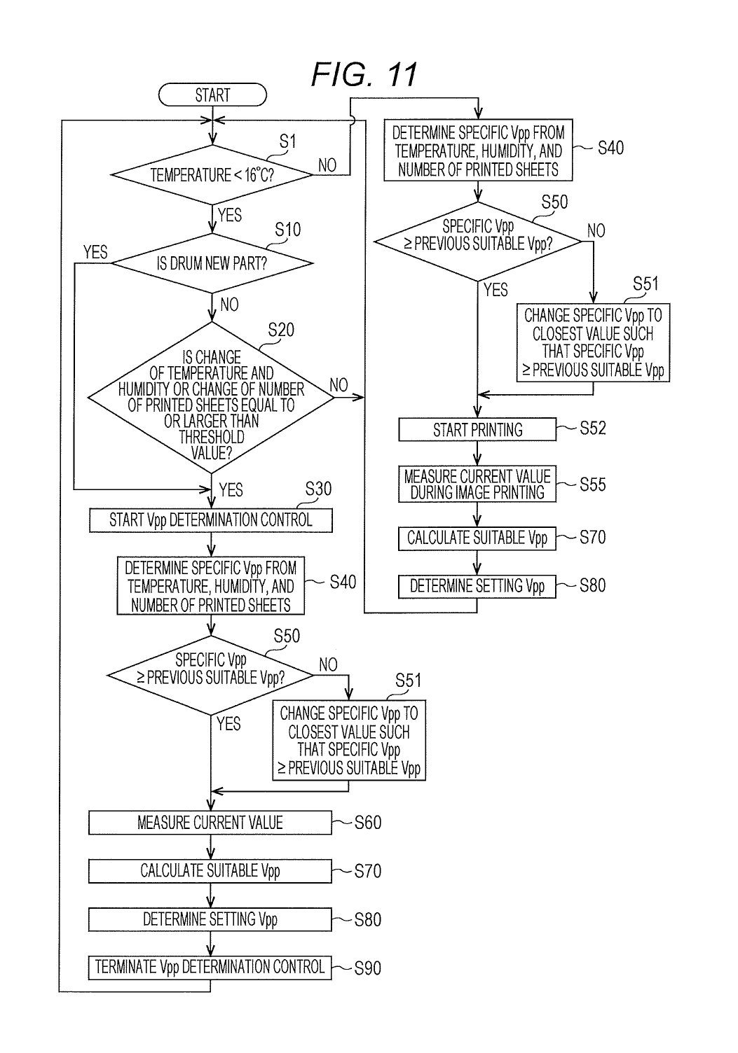

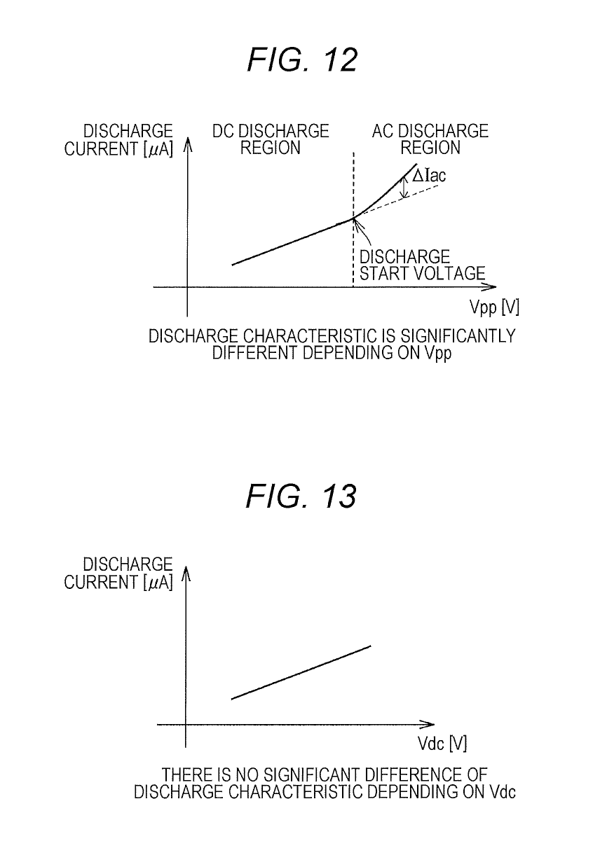

Next, a Vpp determination control in Example 4 will be described with reference to FIG. 11. FIG. 11 is a diagram illustrating the Vpp determination control flow of Example 4. For steps similar to those of Examples 1 to 3, like reference numerals denote like elements, and they will not be described redundantly.

A configuration of the drum unit employed in Example 4 is similar to that of Example 1 of FIG. 5. Under the low-temperature environment (high resistance) lower than a temperature of 16° C. in which a change of the voltage Vpp is significant (step S71), the charging Vpp determination control is executed depending on the environmental change or the number of printed sheets as in Example 1 by combining the control flows of Examples 1 and 3 (steps S80 to S80).

Meanwhile, under the high-temperature environment (low resistance) higher than a temperature of 16° C. in which a change of the voltage Vpp is insignificant (step S71), the Vpp determination control is performed during the image printing as in Example 3 (steps S40 to S52, S55, and S70 to S80).

As a result, it is possible to calculate the suitable voltage Vpp before the image printing even when the difference between the specific voltage Vpp and the suitable voltage Vpp abruptly changes due to a temperature change caused by placing the image forming apparatus 1 in an uncontrolled state. Therefore, it is possible to suppress white and block spots from being generated by a charging failure.

In Example 4, it is assumed that the temperature change type is employed. Alternatively, the Vpp determination control may be performed in response to a temperature trigger while performing the determination control during image printing.

Using the photosensitive member charging method according to the embodiment of the invention, it is possible to uniquely calculate the suitable voltage Vpp with respect to a change in the temperature and humidity, the roller resistance, and the thickness of the photosensitive member by detecting a current change caused by a change of resistance and impedance. Therefore, it is possible to improve followability to the environmental change.

Since the charging state can be directly recognized by observing the current change, there is no influence from a difference between the temperature and humidity inside the image forming apparatus and the temperature and humidity around the charging roller. In addition, it is not necessary to obtain the Vpp-Iac characteristic, it is possible to shorten the control time.

The current can be detected using the specific voltage Vpp that is being sufficiently discharged. For this reason, it is possible to decrease a slope of the suitable voltage Vpp against the current value, increase detection sensitivity, and reduce a variation of electric discharge.

Since a plurality of specific voltages Vpp are provided, it is possible to select a specific voltage Vpp whose difference from the current suitable voltage Vpp is smaller. In addition, it is possible to suppress filming of the external additive caused by electric discharge or thickness reduction of the surface of the photosensitive member while maintaining detection sensitivity.

It is possible to select a process of the specific voltage Vpp depending on a use situation. Therefore, it is possible to improve control accuracy while suppressing a drive distance of the drum unit in the charging Vpp determination.

It is not necessary to provide a plurality of discharge amounts ΔIac in advance depending on the thickness of the photosensitive member, a resistance variation of the charging roller, and the environmental change of the air (temperature and humidity). In addition, it is possible to shorten time necessary in the control.

The processes of FIG. 8 (Example 1), FIG. 9 (Example 2), FIG. 10 (Example 3), and FIG. 11 (Example 4) are implemented, for example, when the processing unit 112 as a CPU executes the program. A part or entirety of each process may be implemented using circuit elements or other hardware components.

Although embodiments of the present invention have been described and illustrated in detail, the disclosed embodiments are made for purposes of illustration and example only and not limitation. The scope of the present invention should be interpreted by terms of the appended claims and intended to include all modifications within the same meaning and range as those of equivalents of the appended claims.

What is claimed is:

1. An image forming apparatus comprising:
a photosensitive member;
a power supply that applies a bias voltage to the photosensitive member to charge a surface of the photosensitive member;
a developer that develops an electrostatic latent image on the photosensitive member;
an exposing device that forms the electrostatic latent image on the photosensitive member;
a hardware processor; and
a memory,
wherein the memory stores, in advance, a relationship between a suitable AC voltage at which a discharge amount of AC electric discharge is balanced between positive and negative sides and a current value of a specific AC voltage set to be equal to or higher than an AC voltage of a discharge start point and be equal to or lower than an AC voltage at which an image defect occurs due to the electric discharge, and
the hardware processor controls the bias voltage in an AC charging type, detects the current value at the specific AC voltage, and determines a setting AC voltage on the basis of the relationship stored in the memory.

2. The image forming apparatus according to claim 1, wherein the suitable AC voltage is lower than the specific AC voltage.

3. The image forming apparatus according to claim 1, wherein the hardware processor has a plurality of the specific AC voltages and selects one of the specific AC voltages depending on temperature and humidity, the number of printed sheets, a thickness of the surface of the photosensitive member, and any one of the previous specific AC voltages.

4. The image forming apparatus according to claim 1, wherein the hardware processor performs the process of determining the specific AC voltage by detecting an environmental change and/or a change of a durable sheet number.

5. The image forming apparatus according to claim 1, wherein the hardware processor performs the process of determining the specific AC voltage whenever the charging starts or ends, or during development.

6. The image forming apparatus according to claim 1, wherein the hardware processor performs the process of determining the specific AC voltage by performing printing at the specific AC voltage set to be lowest as long as small charging irregularity caused by electric discharge irregularity does not occur and determining the suitable AC voltage from a current value during the printing.

7. The image forming apparatus according to claim 1, wherein the hardware processor performs the process of determining the specific AC voltage by detecting an environmental change or a current change under a low-temperature environment in which an AC voltage change is significant, and by switching to a determination control during image printing under a high-temperature environment in which the AC voltage change is insignificant.

8. A method of controlling an image forming apparatus including a photosensitive member, a power supply that applies a bias voltage to the photosensitive member to charge a surface of the photosensitive member, a developer that develops an electrostatic latent image on the photosensitive member, an exposing device that forms the electrostatic latent image on the photosensitive member, a hardware processor, and a memory, the method comprising:
storing in advance, in the memory, a relationship between a suitable AC voltage at which a discharge amount of AC electric discharge is balanced between positive and negative sides and a current value of a specific AC voltage set to be equal to or higher than an AC voltage of a discharge start point and be equal to or lower than an AC voltage at which an image defect occurs due to the electric discharge; and
allowing the hardware processor to control the bias voltage in an AC charging type, detect the current value at the specific AC voltage, and determine a setting AC voltage on the basis of the relationship stored in the memory.

9. A non-transitory recording medium storing a computer readable control program of an image forming apparatus including a photosensitive member, a power supply that applies a bias voltage to the photosensitive member to charge a surface of the photosensitive member, a developer that develops an electrostatic latent image on the photosensitive member, an exposing device that forms the electrostatic latent image on the photosensitive member, a hardware processor, and a memory, the program causing a computer to perform:
storing in advance, by the memory, a relationship between a suitable AC voltage at which a discharge amount of AC electric discharge is balanced between positive and negative sides and a current value of a specific AC voltage set to be equal to or higher than an AC voltage of a discharge start point and be equal to or lower than an AC voltage at which an image defect occurs due to the electric discharge; and
controlling the bias voltage in an AC charging type, detecting the current value at the specific AC voltage, and determining a setting AC voltage on the basis of the relationship stored in the memory by the hardware processor.
